(19) United States
(12) Patent Application Publication
(10) Pub. No.: US 2026/0322855 A1
(43) Pub. Date: Oct. 15, 2026

(54) DETECTION APPARATUS, DETECTION METHOD AND DETECTION PROGRAM

(71) Applicant: NTT, Inc., Tokyo (JP)

(72) Inventors: Takashi KOIDE, Chiyoda-ku, Tokyo (JP); Naoki FUKUSHI, Chiyoda-ku, Tokyo (JP); Hiroki NAKANO, Chiyoda-ku, Tokyo (JP); Daiki CHIBA, Chiyoda-ku, Tokyo (JP)

(73) Assignee: NTT, Inc., Tokyo (JP)

(21) Appl. No.: 19/484,418

(22) PCT Filed: May 31, 2024
(86) PCT No.: PCT/JP2024/020115

§ 371 Date: Nov. 14, 2025

(30) Foreign Application Priority Data
Jun. 1, 2023 (JP) 2023-091248

(51) Int. Cl. H04L 9/40; G06N 3/045

(52) U.S. Cl. CPC H04L 63/1483; G06N 3/045; H04L 63/1416

(57) ABSTRACT

A detection apparatus includes a memory and processing circuitry configured to classify, based on feature values of a plurality of domain names known to be malicious, the plurality of domain names into a plurality of clusters, generate a matching rule for each of the plurality of clusters, and determine whether a detection target domain name is malicious using a matching rule generated for a cluster including a domain name having a similarity to the detection target domain name equal to or larger than a threshold among the plurality of clusters.

### FIELD

The present invention relates to a detection apparatus, a detection method, and a detection program.

### BACKGROUND

An attack called phishing has been known. An attacker uses a phishing site to cause a victim user to erroneously recognize the phishing site as a regular Web site and causes the victim user to input personal information or requests payment of money.

When preparing the phishing site, the attacker sometimes acquires a domain name similar to a domain name of the regular Web site. A method of creating such a domain name is called Domain squatting.

The attacker uses the domain name acquired by the Domain squatting as a domain name of the phishing site or sets the domain name as a URL in an email message. In the Domain squatting, a similar domain name is acquired by replacing with characters with similar characters such as replacing “o” with “0” and replacing “i” with “1” or by replacing with characters with close characters on a keyboard on which a type error can occur.

The attacker sometimes acquires a domain name (example: BRAND-login.test) including a brand name (example: BRAND.test) of a regular service or acquires a domain name (example: BRAND.test.example.com) in which a domain name of a regular Web site is set as a subdomain.

As an existing method of detecting a domain name acquired using the Domain squatting, for example, there is a method of receiving input of a domain name of a regular Web site and generating a similar domain name according to a replacement pattern of characters registered in advance (see, for example, Non Patent Literature 1).

There is a method of detecting a domain name including a brand name of a regular service (see, for example, Non Patent Literature 2). Both the methods are methods of detecting a domain name similar to a domain name of a regular Web site.

### CITATION LIST

### Non Patent Literature

Non Patent Literature 1: Agten P, Joosen W, Piessens F, Nikiforakis N (2015) Seven Months' Worth of Mistakes: A Longitudinal Study of Typosquatting Abuse. In: 22nd Annual Network and Distributed System Security Symposium, NDSS 2015, San Diego, California, USA, February 8-11, 2015. The Internet Society

Non Patent Literature 2: Kintis P, Miramirkhani N, Lever C, Chen Y, Gomez RR, Pitropakis N, Nikiforakis N, Antonakakis M (2017) Hiding in Plain Sight: A Longitudinal Study of Combosquatting Abuse. In: Thuraisingham B, Evans D, Malkin T, Xu D (eds) Proceedings of the 2017 ACM SIGSAC Conference on Computer and Communications Security, CCS 2017, Dallas, TX, USA, October 30-Nov. 3, 2017. ACM, Pp 569-586

### SUMMARY

### Technical Problem

However, in the method of the related art, in some cases, a domain name used for phishing cannot be accurately detected.

In recent years, in order to improve efficiency of creating a large number of domain names and to avoid existing detection techniques, there are domain names generated by combining a plurality of creation methods of the Domain squatting.

For example, there is known a method of configuring a domain name based on a specific naming rule such as setting a character string obtained by modifying a part of a regular domain name as a subdomain, leaving several first characters of a regular domain name and changing the remaining characters, or combining other words.

A domain name generated by such a method is closely similar to the regular domain name but, when compared with the regular domain name, sometimes has different structure or has a few common characters.

### Solution to Problem

In order to solve the above-mentioned problems and achieve the object, a detection apparatus includes: a clustering unit that classifies, based on feature values of a plurality of domain names known to be malicious, the plurality of domain names into a plurality of clusters; a rule generation unit that generates a matching rule for each of the plurality of clusters; and a determination unit that determines whether a detection target domain name is malicious using a matching rule generated for a cluster including a domain name having a similarity to the detection target domain name equal to or larger than a threshold among the plurality of clusters.

### Advantageous Effects of Invention

According to the present invention, it is possible to accurately detect a domain name used for phishing.

### BRIEF DESCRIPTION OF DRAWINGS

FIG. 1 is a diagram illustrating a configuration example of a detection apparatus in a first embodiment.

FIG. 2 is a diagram for explaining processing of the detection apparatus.

FIG. 3 is a diagram for explaining fine tuning.

FIG. 4 is a diagram illustrating an example of triplet data.

FIG. 5 is a diagram for explaining feature extraction processing.

FIG. 6 is a diagram illustrating an example of a feature value.

FIG. 7 is a diagram illustrating an example of a matching rule.

FIG. 8 is a diagram illustrating an example of a matching rule.

FIG. 9 is a diagram illustrating an example of a similarity.

FIG. 10 is a flowchart illustrating a flow of processing of generating a matching rule.

FIG. 11 is a flowchart illustrating a flow of processing of detecting a malicious domain name.

FIG. 12 is a diagram illustrating an example of a computer that executes a program.

### DESCRIPTION OF EMBODIMENTS

Hereinafter, embodiments of a detection apparatus, a detection method, and a detection program according to the present application are explained in detail with reference to the drawings. Note that the present invention is not limited to the embodiments explained below.

### Configuration of a First Embodiment

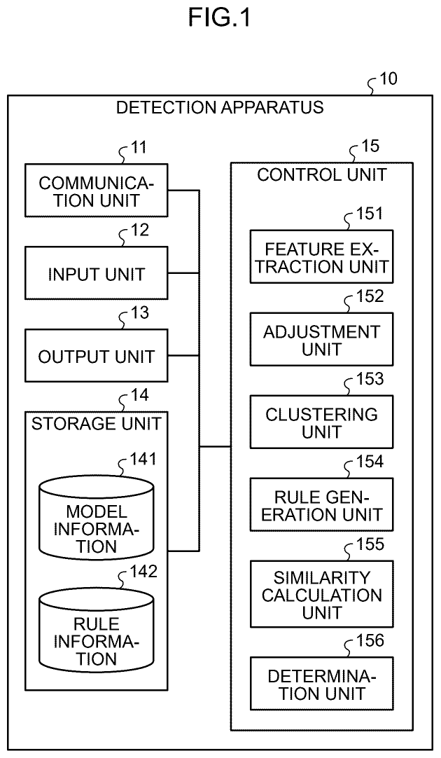

A configuration of a detection apparatus according to a first embodiment is explained with reference to FIG. 1. FIG. 1 is a diagram illustrating a configuration example of the detection apparatus according to the first embodiment.

As illustrated in FIG. 1, the detection apparatus 10 includes a communication unit 11, an input unit 12, an output unit 13, a storage unit 14, and a control unit 15.

The communication unit 11 performs data communication with other apparatuses via a network. For example, the communication unit 11 is an NIC (Network Interface Card).

The input unit 12 receives input of data. For example, the input unit 12 is an interface connected to input devices such as a mouse and a keyboard.

The output unit 13 outputs data. The output unit 13 is an interface connected to output devices such as a display and a speaker.

The storage unit 14 is a storage device such as a HDD (Hard Disk Drive), an SSD (Solid State Drive), or an optical disk. Note that the storage unit 14 may be a semiconductor memory capable of rewriting data, such as a RAM (Random Access Memory), a flash memory, or an NVSRAM (Non Volatile Static Random Access Memory). The storage unit 14 stores an OS (Operating System) and various programs to be executed by the detection apparatus 10.

The storage unit 14 stores model information 141 and rule information 142. The model information 141 is ro parameter for constructing a machine learning model. For example, the model information 141 is parameters such as a weight and a bias of the deep neural network. The rule information 142 is a set of matching rules explained below.

The control unit 15 controls the entire detection apparatus 10. The control unit 15 is, for example, an electronic circuit such as a CPU (Central Processing Unit), an MPU (Micro Processing Unit), or a GPU (Graphics Processing Unit) or an integrated circuit such as an ASIC (Application Specific Integrated Circuit) or an FPGA (Field Programmable Gate Array).

The control unit 15 includes an internal memory for storing programs defining various processing procedures and control data and executes respective kinds of processing using the internal memory. The control unit 15 functions as various processing units by various programs operating. For example, the control unit 15 functions as a feature extraction unit 151, an adjustment unit 152, a clustering unit 153, a rule generation unit 154, a similarity calculation unit 155, and a determination unit 156.

The feature extraction unit 151 extracts a feature value from a domain name using a machine learning model constructed based on the model information 141. The adjustment unit 152 performs tuning of the machine learning model. The clustering unit 153 classifies a plurality of domain names into a plurality of clusters based on the feature value. The rule generation unit 154 generates a matching rule for each cluster. The similarity calculation unit 155 calculates a similarity between a detection target domain name and a domain name included in the cluster. The determination unit 156 determines whether the detection target domain name is malicious using a matching rule generated for, among a plurality of clusters, a cluster including a domain name having a similarity to the detection target domain name equal to or larger than a threshold.

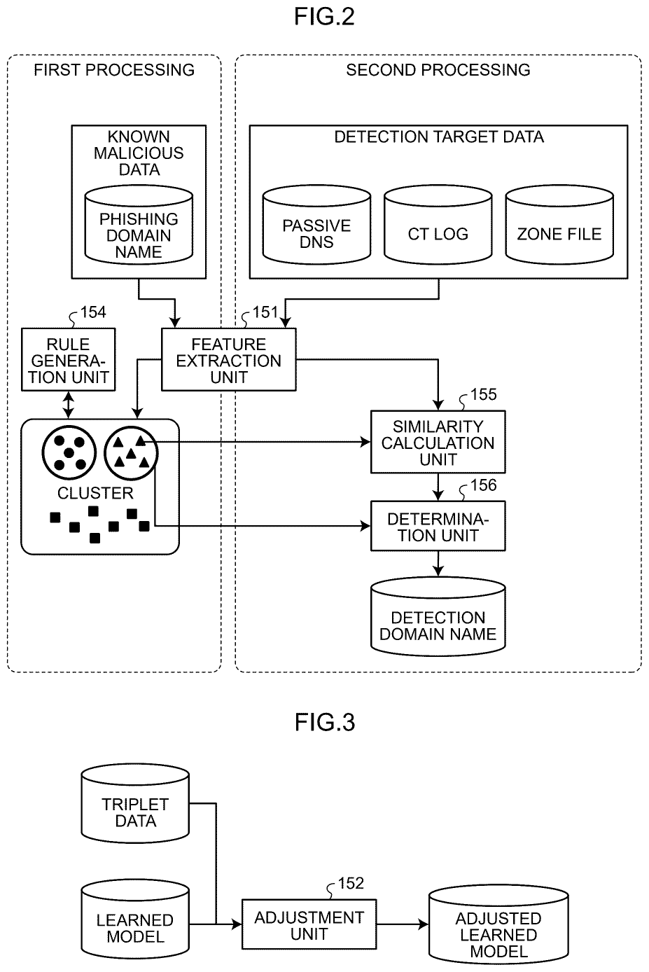

Processing of the detection apparatus 10 is explained with reference to FIG. 2. FIG. 2 is a diagram for explaining the processing of the detection apparatus. As illustrated in FIG. 2, the detection apparatus 10 performs first processing and second processing. The first processing is processing of generating a matching rule. The second processing is processing of detecting a malicious domain name (for example, a domain name used for phishing) using the matching rule.

### First Processing

As illustrated in FIG. 2, in the first processing, a phishing domain name is input to the detection apparatus 10 as known maliciousness data. The phishing domain name is a list (a black list) of domain names known as having been used for phishing.

The feature extraction unit 151 extracts a feature value of the input phishing domain name using a machine learning model (hereinafter simply referred to as model) constructed from the model information 141. The feature extraction unit 151 can extract a feature value using a model for converting a character string into vector data. For example, the feature extraction unit 151 extracts a feature value using BERT (Bidirectional Encoder Representations from Transformers), which is a deep learning method.

A model such as the BERT is sometimes already trained using a large corpus in order to analyze linguistic features of general sentences and conversational sentences. Thus, the adjustment unit 152 performs fine tuning in order to optimize the model such as the BERT for an analysis of a domain name, which is a short character string.

The fine tuning is a method of relearning a part (for example, only an output layer) of the learned model using a prepared data set such that the part can be adapted to a specific task.

In the fine tuning, learning is performed using a data set adapted to a loss function to be set. For example, the loss function is a Triplet Loss. As illustrated in FIG. 3, the adjustment unit 152 adjusts the learned model based on the triplet data and outputs the adjusted learned model. FIG. 3 is a diagram for explaining the fine tuning.

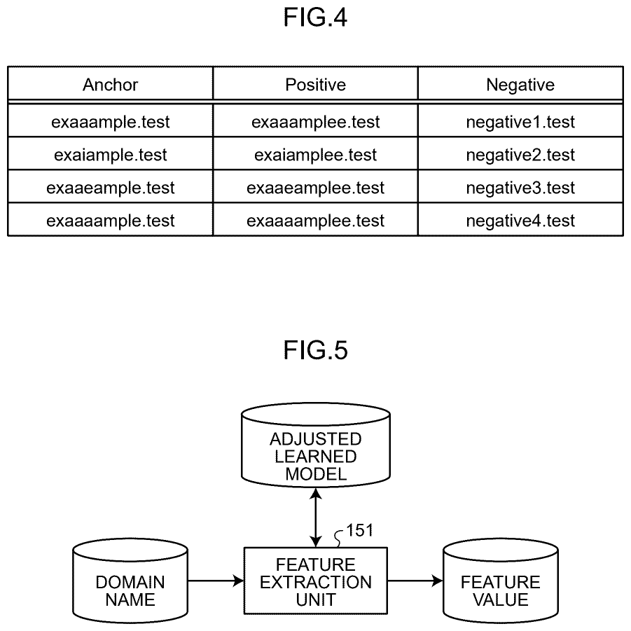

As illustrated in FIG. 4, the triplet data is a triplet data of a sentence that is Anchor, a sentence (Positive) similar to Anchor, and a sentence (Negative) not similar to Anchor. FIG. 4 is a diagram illustrating an example of the triplet data.

The Triplet loss is a loss function for performing learning to reduce the distance between similar data (Anchor and Positive) and increase the distance between dissimilar data (Anchor and Negative). Note that the distance referred to here is a distance (a cosine similarity, a Euclidean distance, or the like) between vectors representing feature values.

For example, the adjusted BERT that has been fine-tuned using the triplet data illustrated in FIG. 4 outputs feature values similar to each other for a domain name “exaaample. test”, which is Anchor, and a domain name “exaaamplee. test”, which is Positive. On the other hand, the adjusted BERT outputs feature values dissimilar to each other for the domain name “exaaample. test”, which is Anchor, and a domain name “negativel. test”, which is Negative.

As illustrated in FIG. 5, the feature extraction unit 151 extracts a feature value from a plurality of domain names known to be malicious using BERT adapted to the domain name by fine tuning with use of Triplet Loss. FIG. 5 is a diagram for explaining feature extraction processing.

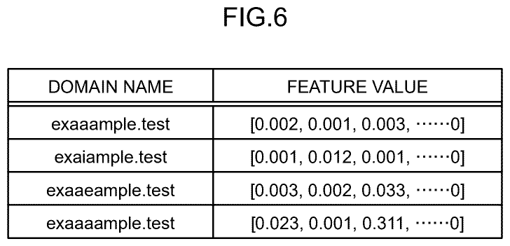

As illustrated in FIG. 6, a feature value is represented as vector data. FIG. 6 is a diagram illustrating an example of the feature value.

The clustering unit 153 classifies a plurality of domain names into a plurality of clusters based on feature values of a plurality of domain names known to be malicious. The clustering unit 153 performs clustering based on a feature value that is vector data. The clustering unit 153 may perform clustering using an algorithm such as DBSCAN (Density-based Spatial Clustering of Applications with Noise) for which the number of clusters does not need to be set.

The clustering unit 153 excludes a domain name not belonging to any clusters as a result of the clustering. Accordingly, the remaining domain name belongs to any one of the clusters.

Referring back to FIG. 2, the rule generation unit 154 generates a matching rule for each of the plurality of clusters. For example, the rule generation unit 154 generates matching rules concerning a character string of any level included in each of the plurality of domain names and the number of characters of each of the plurality of domain names.

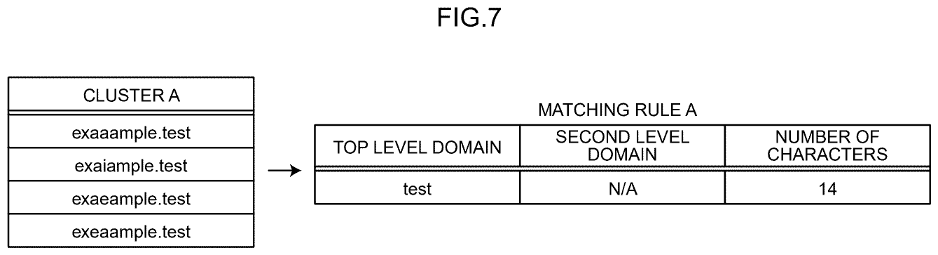

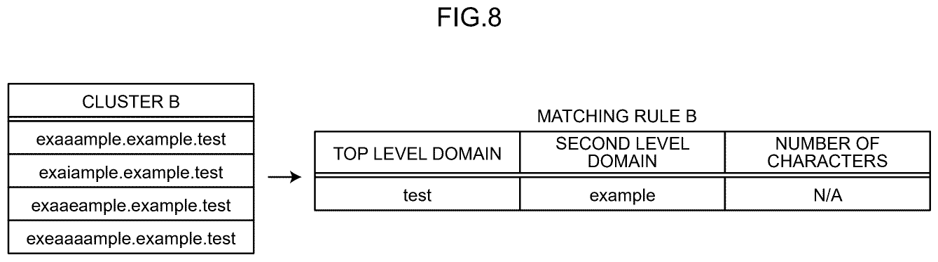

FIG. 7 and FIG. 8 are diagrams illustrating examples of matching rules. A cluster A and a cluster B are clusters classified by the clustering unit 153.

As illustrated in FIG. 7, a plurality of domain names classified into the cluster A are common to one another in that a top level domain is “test”. The plurality of domain names classified into the cluster A are common to one another in that the number of characters is fourteen. On the other hand, second level domains of the plurality of domain names classified as the cluster A include “exaaample”, “exaiample”, and the like, and are not common.

Thus, the rule generation unit 154 generates, for the cluster A, a matching rule A that the top level domain is “test” and the number of characters is “14”.

As illustrated in FIG. 8, a plurality of domain names classified into the cluster B are common to one another in that a top level domain is “test”. The plurality of domain names classified into the cluster B is common in that a second level domain is “example”. On the other hand, the numbers of characters of the plurality of domain names classified into the cluster B are not common.

Thus, the rule generation unit 154 generates, for the cluster B, a matching rule B that the top level domain is “test” and the second level domain is “example”.

### Second Processing

Subsequently, second processing illustrated in FIG. 2 is explained. As illustrated in FIG. 2, in the second processing, domain names acquired from a passive DNS (Domain Name System), a CT (Certificate Transparency) log, and a zone file are input to the detection apparatus 10 as detection target data.

The domain name of the detection target data is a domain name registered or observed anew. It may be unknown whether the domain name is used for phishing.

Note that the passive DNS is data obtained by observing a DNS cache server. The CT log is a domain name acquired anew and is a domain name for which a certificate authority has disclosed a certificate. The zone file is a file set in an authoritative DNS server and is a file that associates a domain name and an IP address.

The feature extraction unit 151 extracts a feature value of the domain name included in the detection target data with the same method as the method of the first processing.

The similarity calculation unit 155 calculates a similarity (a cosine similarity, a Euclidean distance, or the like) between feature values of domain names included in the detection target data and feature values of clustered domain names included in known maliciousness data.

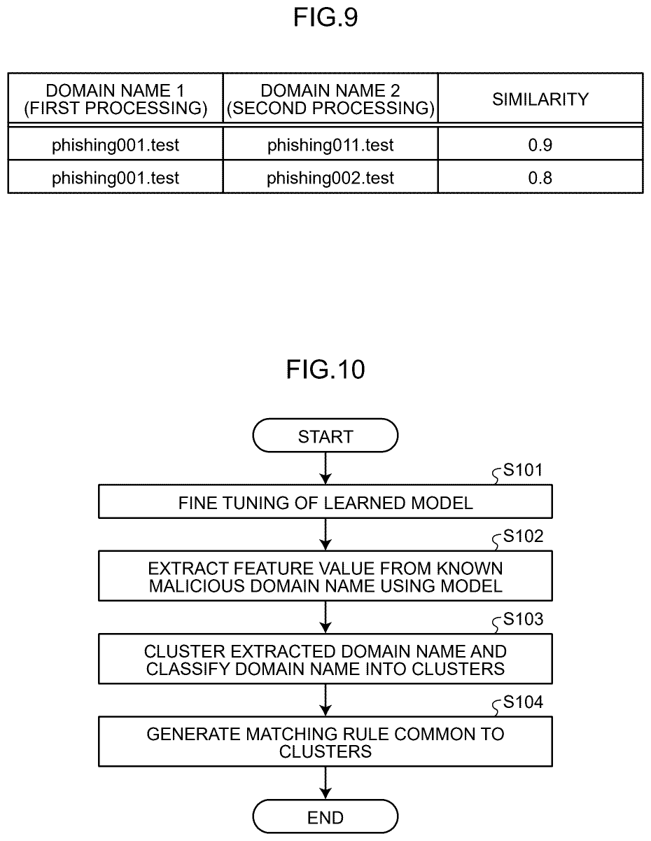

FIG. 9 is a diagram illustrating an example of a similarity. “phishing001.test” is a domain name included in a known phishing domain name and has been clustered in the first processing. “phishing011.test” and “phishing002. test” are domain names included in the detection target data.

The similarity calculation unit 155 calculates a similarity between “phishing001.test” and “phishing011.test” as “0.9”. The similarity calculation unit 155 calculates a similarity between “phishing001.test” and “phishing002.test” as “0.8”.

Then, the determination unit 156 determines whether the detection target domain name is malicious using a matching rule generated for, among the plurality of clusters, a cluster including a domain name having a similarity to the detection target domain name equal to or larger than a threshold.

For example, assuming that the threshold is 0.85 in the example illustrated in FIG. 9, the determination unit 156 determines, using the matching rule, whether “phishing011.test”, the similarity of which exceeds the threshold, is malicious. On the other hand, the determination unit 156 does not perform determination using the matching rule for “phishing002.test”, the similarity of which is equal to or smaller than the threshold.

As explained above, the determination unit 156 determines whether the detection target domain name obtained from the CT log, the passive DNS, or the zone file is malicious.

For example, it is assumed that “www.example.co.test” is known as a regular domain name.

In this case, the following domain names can be the detection target domain name.
www.exampppliie.exampppllleaee.co.test.abcdeg.test
www.examppplss.examplllaaeeee.co.test.bcdegh.test
www.examppaaie.examppaaeelee.co.test.cdeghi.test
www.examppeeie.examppaaleeee.co.test.deghij.test

### Flow of Processing in the First Embodiment

A flow of first processing, that is, processing of generating a matching rule is explained with reference to FIG. 10. FIG. 10 is a flowchart illustrating a flow of processing of generating a matching rule.

As illustrated in FIG. 10, first, the detection apparatus 10 performs fine tuning of a learned model (step S101). For example, the detection apparatus 10 performs fine tuning of BERT with a Triplet Loss.

Subsequently, the detection apparatus 10 extracts a feature value from a known malicious domain name using the fine-tuned model (step S102). The detection apparatus 10 extracts a feature value as vector data.

Subsequently, the detection apparatus 10 performs clustering of extracted domain names and classifies the domain names into clusters (step S103). The detection apparatus 10 may exclude a domain name not classified into clusters.

Then, the detection apparatus 10 generates a matching rule common to the clusters (step S104). For example, the detection apparatus 10 generates a matching rule based on a top level domain, a second level domain, or the number of characters of a domain name.

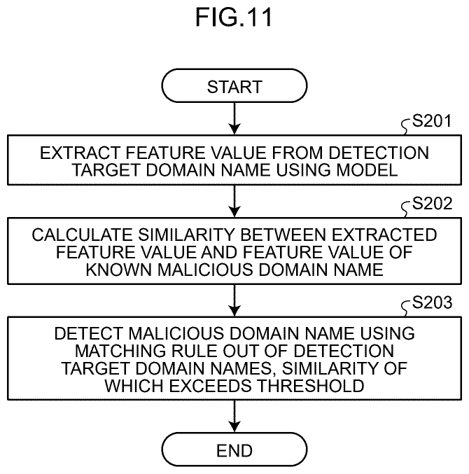

A flow of second processing, that is, processing of detecting a malicious domain name is explained with reference to FIG. 11. FIG. 11 is a flowchart illustrating the flow of the processing of detecting a malicious domain name.

As illustrated in FIG. 11, first, the detection apparatus 10 extracts a feature value from a domain name of a detection target using a model (step S201). At this time, the detection apparatus 10 uses the same model as the model in the first processing.

Subsequently, the detection apparatus 10 calculates a similarity between the extracted feature value and the feature value of the known malicious domain name (step S202). For example, the detection apparatus 10 calculates the distance between vectors as the similarity.

The detection apparatus 10 detects a malicious domain name out of detection target domain names, similarities of which exceed the threshold, using the matching rule (step S203). The detection apparatus 10 outputs a domain name matching the matching rule among the domain names, the similarities of which exceed the threshold, as a domain name that is likely to be used for phishing.

### Effects of the First Embodiment

As explained above, the clustering unit 153 classifies a plurality of domain names into a plurality of clusters based on feature values of a plurality of domain names known to be malicious. The rule generation unit 154 generates a matching rule for each of the plurality of clusters. The determination unit 156 determines whether the detection target domain name is malicious using a matching rule generated for, among a plurality of clusters, a cluster including a domain name having a similarity to the detection target domain name equal to or larger than a threshold.

As explained above, the detection apparatus 10 performs detection for a detection target domain name similar to the known phishing domain name using a matching rule conforming to the phishing domain name. As a result, the detection apparatus 10 can accurately detect even a complicated phishing domain name created by combining a plurality of Domain squatting methods.

Furthermore, the detection apparatus 10 can detect a domain name before the domain name is acquired by an attacker and used as a phishing site or at an initial stage when the domain name is started to be used. By using these domain names, it is possible to prevent a user from accessing a phishing site.

The feature extraction unit 151 extracts a feature value from a plurality of domain names known to be malicious using BERT adapted to a domain name by fine tuning with use of Triplet Loss. The clustering unit 153 classifies the plurality of domain names into a plurality of clusters based on the feature value extracted by the feature extraction unit 151. A phishing domain name is sometimes created by a common naming rule. The detection apparatus 10 can grasp linguistic similarity of domain names by using a machine learning model such as the BERT.

The rule generation unit 154 generates a matching rule concerning a character string at any level included in each of the plurality of domain names and the number of characters of each of the plurality of domain names. Accordingly, the detection apparatus 10 can perform detection using both linguistic information and meta information such as the number of characters.

The determination unit 156 determines whether a detection target domain name obtained from the CT log, the passive DNS, or the zone file is malicious. Accordingly, it is possible to efficiently obtain a detection target domain name.

### System Configuration and the Like

The components of the illustrated apparatuses are functionally conceptual and are not required to be physically configured as illustrated. That is, a specific form of distribution and integration of the apparatuses is not limited to the illustrated form and all or some of the apparatuses can be functionally or physically distributed or integrated in any unit according to various loads, usage situations, and the like. Furthermore, all or any part of the processing functions performed in the apparatuses can be implemented by a CPU and a program analyzed and executed by the CPU or can be implemented as hardware by wired logic.

Among the kinds of processing explained in the present embodiment, all or some of the kinds of processing explained as being automatically performed can also be manually performed or all or some of the kinds of processing explained as being manually performed can also be automatically performed by a publicly known method. Besides, the processing procedures, the control procedures, the specific names, and the information including various data and parameters illustrated in the document and the drawings can be optionally changed unless specifically noted otherwise.

### Program

As an embodiment, the detection apparatus 10 can be implemented by causing a desired computer to install, as package software or online software, a program for executing the learning processing explained above. For example, by causing an information processing apparatus to execute the program explained above, it is possible to cause the information processing apparatus to function as the detection apparatus 10. The information processing apparatus referred to here includes a desktop or notebook personal computer. Besides, the category of the information processing apparatus includes mobile communication terminals such as a smartphone, a mobile phone, and a PHS (Personal Handyphone System) and further includes a slate terminal such as a PDA (Personal Digital Assistant).

The detection apparatus 10 can also be implemented as a server apparatus that sets a terminal device used by a user as a client and provides a service concerning the processing explained above to the client. For example, the server apparatus is implemented as a server apparatus that provides a service for receiving input of a detection target domain name and outputting a determination result as to whether the domain name is malicious. In this case, the server apparatus may be implemented as a Web server or may be implemented as a cloud that provides, by outsourcing, a service concerning the processing explained above.

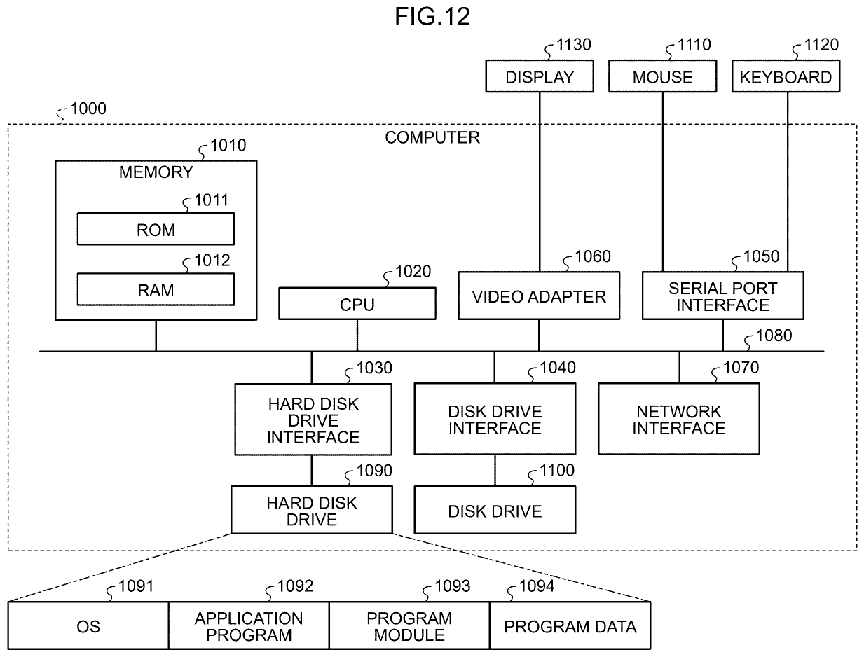

FIG. 12 is a diagram illustrating an example of a computer that executes a program. A computer 1000 includes, for example, a memory 1010 and a CPU 1020. The computer 1000 also includes a hard disk drive interface 1030, a disk drive interface 1040, a serial port interface 1050, a video adapter 1060, and a network interface 1070. These units are connected by a bus 1080.

The memory 1010 includes a ROM (Read Only Memory) 1011 and a RAM (Random Access Memory) 1012. The ROM 1011 stores, for example, a boot program such as a BIOS (Basic Input Output System). The hard disk drive interface 1030 is connected to the hard disk drive 1090. The disk drive interface 1040 is connected to the disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program defining the respective kinds of processing of the detection apparatus 10 is implemented as the program module 1093 in which a code executable by a computer is described. The program module 1093 is stored in, for example, the hard disk drive 1090. For example, the program module 1093 for executing the same processing as the functional configuration in the detection apparatus 10 is stored in the hard disk drive 1090. The hard disk drive 1090 may be substituted by an SSD (Solid State Drive).

Setting data used in the processing in the embodiment explained above is stored in, for example, the memory 1010 or the hard disk drive 1090 as the program data 1094. The CPU 1020 reads the program module 1093 and the program data 1094 stored in the memory 1010 and the hard disk drive 1090 to the RAM 1012 according to necessity and executes the processing in the embodiment explained above.

Note that the program module 1093 and the program data 1094 are not limited to being stored in the hard disk drive 1090 and may be stored in, for example, a removable storage medium and read by the CPU 1020 via the disk drive 1100 or the like. Alternatively, the program module 1093 and the program data 1094 may be stored in another computer connected via a network (a LAN (Local Area Network) or a WAN (Wide Area Network), or the like). The program module 1093 and the program data 1094 may be read by the CPU 1020 from another computer via the network interface 1070.

### REFERENCE SIGNS LIST

10 DETECTION APPARATUS
11 COMMUNICATION UNIT
12 INPUT UNIT
13 OUTPUT UNIT
14 STORAGE UNIT
15 CONTROL UNIT
141 MODEL INFORMATION
142 RULE INFORMATION
151 FEATURE EXTRACTION UNIT
152 ADJUSTMENT UNIT
153 CLUSTERING UNIT
154 RULE GENERATION UNIT
155 SIMILARITY CALCULATION UNIT
156 DETERMINATION UNIT

1. A detection apparatus comprising:
a memory; and
processing circuitry configured to:
classify, based on feature values of a plurality of domain names known to be malicious, the plurality of domain names into a plurality of clusters;
generate a matching rule for each of the plurality of clusters; and
determine whether a detection target domain name is malicious using a matching rule generated for a cluster including a domain name having a similarity to the detection target domain name equal to or larger than a threshold among the plurality of clusters.

2. The detection apparatus according to claim 1, wherein the processing circuitry is further configured to
extract a feature value from the plurality of domain names known to be malicious using Bidirectional Encoder Representations from Transformers adapted to the domain name by fine tuning with use of Triplet Loss, and
classify the plurality of domain names into a plurality of clusters based on the feature value extracted.

3. The detection apparatus according to claim 1, wherein
the processing circuitry is further configured to generate a matching rule concerning a character string at any level included in each of the plurality of domain names and a number of characters of each of the plurality of domain names.

4. The detection apparatus according to claim 1, wherein the processing circuitry is further configured to determine whether the detection target domain name obtained from a Certificate Transparency log, a passive Domain Name System, or a zone file is malicious.

5. A detection method executed by a detection apparatus, comprising:
classifying, based on feature values of a plurality of domain names known to be malicious, the plurality of domain names into a plurality of clusters;
generating a matching rule for each of the plurality of clusters; and
determining whether a detection target domain name is malicious using a matching rule generated for a cluster including a domain name having a similarity to the detection target domain name equal to or larger than a threshold among the plurality of clusters.

6. A non-transitory computer-readable recording medium storing therein a detection program that causes a computer to execute a process comprising:
classifying, based on feature values of a plurality of domain names known to be malicious, the plurality of domain names into a plurality of clusters;
generating a matching rule for each of the plurality of clusters; and
determining whether a detection target domain name is malicious using a matching rule generated for a cluster including a domain name having a similarity to the detection target domain name equal to or larger than a threshold among the plurality of clusters.
